(19) United States
(12) Patent Application Publication
(10) Pub. No.: US 2022/0383181 A1
(43) Pub. Date: Dec. 1, 2022

(54) METHOD AND SYSTEM FOR FACILITATING CLASSIFICATION

(71) Applicant: Armand Erik Prieditis, McKinleyville, CA (US)

(72) Inventor: Armand Erik Prieditis, McKinleyville, CA (US)

(21) Appl. No.: 17/318,635

(22) Filed: May 12, 2021

(51) Int. Cl. G06N 20/00; G06N 7/00

(52) U.S. Cl. CPC G06N 20/00; G06N 7/005

(57) ABSTRACT

Embodiments of the subject matter can facilitate classification by leveraging proximity in space, time, and relationships. Embodiments of the subject matter can be applied to data structures including but not limited to one dimensional arrays such as an audio signals, words, and DNA sequences; two dimensional arrays such as images; three dimensional arrays such as videos or volumetric images, higher-dimensional arrays such as volumetric videos; and graphs with nodes and edges such as in chemical structures. Embodiments of the subject matter have several advantages. First, they can result in greater classification accuracy because they can leverage proximity. Second, these embodiments are more efficient and don't require as much training time because they don't require backpropagation to update parameters. Third, they can't easily be fooled by the injection of spurious information and won't easily see patterns where there are none because they don't use unsupervised learning. Fourth, they can easily be parallelized over the number of features and over the number of training examples. Fifth, these embodiments can also be generative. For example, they can be used to generate an image given a classification such as a caption.

### BACKGROUND

### Field

The subject matter relates to classification. Classification involves determining a class based on an input. A class can be a property of the whole input even though it can be based on individual elements of the input. For example, a class might correspond to whether or not a dog is in an image. A class can also be a property of each individual element of the input. For example, each element of an image might correspond to whether or not it belongs to a dog.

### Related Art

Image classification is one of the more popular classification applications. Hence, the description of related art will focus on image classification as a vehicle for describing classification in general.

Image classification can be challenging because a particular image can be rotated, warped, reflected, and can vary in size. These challenges can make developing an image classifier expensive and time-consuming, and can result in poor classification performance.

As a result, the dominant method of image classification involves machine learning, which can take into account rotation, warping, reflection, and size differences while providing greater classification accuracy than a manually developed classifier. Machine learning typically comprises training a system on a set of image-class pairs so that the system can later classify an unseen image while generalizing over rotations, warping, reflection, and size differences.

A prominent approach to machine learning an image classifier involves a Convolutional Neural Network (CNN). A CNN comprises one or more layers of Convolution, Pooling, Rectified Linear Units (ReLUs), Units followed by one or more fully connected layers of a neural net.

Convolution involves applying one or more filters to an image. For example, if the original image is a 7680×4320×3 array of intensities, a filter might comprise a 5×5×3 array of continuous values. The last dimension refers to the number of channels. For example, an image typically has three channels: Red, Green, and Blue. Each channel is associated with its own intensity, which is typically between 0 and 255.

During convolution, this filter can slide over each 5×5×3 section of an image to determine a new value based on the 5×5×3 filter. For example, the filter might determine the dot product the 5×5×3 section in the image and the 5×5×3 filter. Although some special processing is required for corners and edges, the result is a new image also comprising a 7680×4320×3 array. In general, a filter can combine information from different parts of the image to reduce a CNN's sensitivity to rotations, reflection, and other transformations.

A filter can also combine multiple channels through normalization. For example, a filter can create a single 7680×4320 array from a 7680×4320×3 array by normalizing over the three channels when applying a filter. The idea is that these reductions can be applied so that the results can eventually be compact enough to fit a standard neural net. Many other filtering techniques can be used and more than one filter can be applied to an image, which can result in a “stacked” set of images.

After Convolution, a CNN can apply Pooling to reduce each image in a stack of images. Pooling involves choosing a window size and a stride length, walking the window across each image stack based on the stride length, and then determining the maximum value in each window. This maximum value replaces the window in the image, thus reducing the size of the input image. The larger the window, the greater the reduction of the input image. Pooling also helps to reduce the sensitivity to location because the particular location of the maximum value doesn't matter.

After Pooling, a CNN can apply a ReLU operation. This operation replaces each negative value with a zero and leaves each positive value untouched. This step is also known as “applying a non-linearity,” which can facilitate classification accuracy.

Convolution, Pooling, and ReLUs can repeat and in possibly different orders until the set of resulting images is small enough to be flattened into a vector that can then be fed into one or more layers of a neural net.

One of the most appealing characteristics of a CNN is that the CNN can be learned from training data. Usually, the most expensive part of CNN training is learning the filters. Learning a filter typically involves randomly initializing the weights of the filters and the neural net at the end, feeding a training example into the CNN, determining the error on the output side, and then using backpropagation to make adjustments to the weights so that the model will be less wrong next time.

Most CNNs are trained using both forward and backpropagation throughout the entire network on each training iteration. Unfortunately, backpropagation can essentially randomize the weights far away from the output. This is because the layers between the input and output can dilute a backpropagation signal. The more layers, the greater the dilution.

Fortunately, deep learning was invented precisely to avoid the need for backpropagation through every layer of a deep network. Instead of backpropagation, deep learning relies on unsupervised learning for all but the last layer in deep networks. This type of unsupervised learning also has a beneficial side-effect: the learned parameters can be re-used for multiple prediction targets. For example, a CNN can be trained with unsupervised learning on millions of images and then flexibly used for multiple different prediction targets.

CNNs have been successfully applied to several applications including LeNet on the MNIST handwriting dataset (99.2% accuracy), AlexNet, which significantly outperformed the second runner-up in the ImageNet competition in 2014, ZFNet, which improved on AlexNet, by tweaking hyperparameters, expanding the size of the middle convolutional layers, and making the stride and filter size on the first layer smaller, GooGLeNet, which reduced the number of parameters from 60M in AlexNet to 4M while improving performance, VGGNet, which showed that the depth of the network is a critical hyperparameter for good performance, and ResNet, which features skip connections, batch normalization, and does not include a fully connected layer at the end of the network. CNNs have also been applied to games such as Go and drug discovery.

CNNs (and more generally neural networks) have been touted as biologically-inspired. This is because mammals visually perceive the world around them using a layered architecture of neurons in the brain. Anecdotal evidence suggests that neural net layers closer to the original input extract low-level features, such as edges, and those layers closer to the output extract concepts that are more abstract, such as parts of an object.

Despite these impressive results, CNNs suffer from several shortcomings. First, as mentioned, backpropagation can fail on deep networks and end up with essentially random parameters high up in the network. Second, unsupervised learning appears to be a solution to this problem, but can result in parameters that are uncorrelated to the target class. For example, noise visually undetectable to a human can be injected into an image so that a CNN grossly misclassifies the image: a lion can be misclassified as a library. Worse still, images that are perceived to a human as noise can be classified as meaningful by a CNN. Creating negative training examples of such misclassifications and then retraining the CNN doesn't appear to help: the problem appears to be intrinsic to the basic architecture of the CNN. A new batch of fooling images can be generated that can continue to fool a CNN, even after multiple retrainings.

Third, a ReLU can drop information that could be valuable in classification. For example, ReLUs change all negative values to zero. There is no reason to believe that negative values carry less information than positive values.

Fourth, CNNs typically have a plethora of hyperparameters that require tuning: the number of features in a filter, the size of the filter, window size for pooling, window stride, number of hidden units in the final layer, and the number and type of layers. All of this tuning can introduce biases and make reproducibility difficult because it is not clear whether credit is due to a CNN or a human tuner.

Fifth, even a simple CNN application can require millions of parameters that result from deeply stacked convolutional layers. For example, a three-dimensional computerized tomography scan input to a CNN with 64 filters can require 137 GB of memory. This means that CNNs often require large computational engines or specialized hardware to produce results quickly.

In contrast, a Hidden Markov Models (HMMs) doesn't suffer from many of the shortcomings of a CNN. An HMM typically comprises a probability distribution over an initial state, a transition function from one state to another, and a probability of an observation at a particular state. The objective of an HMM is to determine a most likely sequence of states for a particular sequence of observations.

Unlike a CNN, which propagates information through Convolution and Pooling, an HMM propagates information through state changes that occur from element to element in a sequence. Also, unlike a CNN, an HMM does not require accoutrements such as Convolution, defining stride lengths, Pooling, and extensive hyperparameter tuning, all of which can introduce their own biases and make reproducibility difficult. Like a CNN, an HMM is machine learnable from data. However, unlike a CNN, an HMM can be efficiently learned and used for prediction with Dynamic Programming.

HMMs have been successfully applied to natural language processing, speech recognition, machine maintenance, acoustics, biosciences, handwriting analysis, text recognition, gene sequencing, intrusion detection, gesture recognition, and image processing.

HMMs have a few shortcomings. First, they don't appear to generalize to more than one dimension. The scientific literature describes “2D” HMMs, but these are typically pseudo-2D (i.e., rows or columns as inputs) or they make strong assumptions about confluences involved in Dynamic Programming, which simply don't occur in most applications. Second, HMIs aren't easily parallelizable because the Dynamic Programming it uses is inherently sequential.

Hence, what is needed is a method and a system for classification the doesn't suffer from the shortcomings of CNNs and that leverages the state-based propagation, simplicity, and efficiency of HMMs, but is applicable to more than one dimension and is easily parallelizable.

### SUMMARY

Embodiments of the subject matter can facilitate classification by leveraging proximity (locality) of locations. Here, proximity refers to nearness in location, where a location includes but is not limited to a position in space, time, channel, or relationship. More generally, a location refers to an index for a data structure, where the index can be used to retrieve content in the data structure, and proximity refers to the nearness of one index to another. Proximity is not reflexive: a location is not in proximity to itself.

Embodiments of the subject matter can be applied to data structures including but not limited to a one-dimensional array such as an audio signal, a sentence of words, and a DNA sequence; a two-dimensional array such as an image, a three-dimensional array such as a video or volumetric image, and a higher-dimensional array such as a volumetric video. In an array, a location can refer to space, time, depth, or channel.

Embodiments of the subject matter can also be applied to a graph with nodes and edges such as in a chemical structure. In a graph, node identifiers can serve as an index and proximity can be defined in terms of edges or weighted edges.

The data structure is not required to be of fixed size, fixed dimensions, or fixed configuration during training or prediction. For example, an audio sequence can be of differing length for training or prediction. Moreover, an image or video can change size and can be ragged in its structure.

For convenience of notation, these embodiments of the subject matter will be referred to here as Resonators. Resonators have several advantages over previous approaches. First, they can result in greater classification accuracy because they can leverage proximity. Second, Resonators are more efficient and don't require as much training time because they don't require backpropagation to update parameters. Third, Resonators can't easily be fooled by the injection of spurious information and won't easily see patterns in random data because they don't use unsupervised learning—every element of the input is conditioned on the class.

Fourth, Resonators can easily be parallelized in several ways. For example, a 7680×4320×3 image can be parallelized into 99,532,800 independent computations, one for each location in the image array. Multiple random restarts, which will be described shortly, can also be parallelized.

Another type of parallelism that Resonators can leverage is during learning: Resonators can process each training example in parallel. For example, 100000 images can be trained in parallel, providing a 100000× speedup in learning.

Fifth, Resonators can also be generative. For example, they can generate an image given a classification (e.g., a caption).

The details of one or more embodiments of the subject matter are set forth in the accompanying drawings and the description below. Other features, aspects, and advantages of the subject matter will become apparent from the description, the drawings, and the claims.

### BRIEF DESCRIPTION OF THE FIGURES

FIG. 1 presents an example system for facilitating classification.

In the FIGURES, like reference numerals refer to the same FIGURE elements.

### DETAILED DESCRIPTION

During operation, a classification system in accordance with an embodiment of the subject matter can execute the following steps:

$$∀ l ∈ L , ∀ c ∈ C : {s}_{l , c} = {random}_{t ∈ S} \{ p ( {a}_{l} , t \vert y ( l , L ) , c ) \} \qquad 1.$$

$$∀ l ∈ L , ∀ c ∈ C : {s}_{l , c}^{′} = {argmax}_{t ∈ S} \{ p ( {a}_{l} , t \vert {a}_{n ( l , L )} , {s}_{n ( l , L ) , c} , y ( l , L ) , c ) \} \qquad 2.$$

3. s=s′
4. Repeat steps 2-3 until termination criteria is met.

Here, L refers to a non-empty set of locations; C refers to a non-empty set of classes, whose elements can be discrete values; and S refers to a non-empty set of states, whose elements can be discrete values. For example, the set of locations L might comprise x, y, d coordinates for an array such as an image, where x comprises a width coordinate, y comprises a height coordinate, and d comprises the channel (i.e., Red, Green, or Blue). In an animal classification application, the set of classes C might comprise {dog, cat, gerbil}, and the set of states might comprise {0,1,2,3,4,5}. Here the term “discrete” refers to a finite set of values. For example, a finite subset of integers can be discrete. In particular, an integer can be used as part of an index for a data structure.

In this embodiment of the subject matter, the class can be a property of the entire input data structure a. In other embodiments of the subject matter (i.e., segmentation), which will be described later, a class can be a property of each respective element of the input data structure a.

Because states can be missing in the input, states are often referred to as “hidden” in the HMM literature. Here, they are simply called “states” to avoid confusion with items such as “hidden” units of neural networks. Typically, the number of states required for a particular prediction task will be proportional to the complexity of the prediction task. The more complex the prediction task, the more states.

The expression s_{l,c} refers to content (i.e., a state value) at location l for class c in state data structure s. For example s_{x,y,d,c} might correspond to content at location x, y, d for class c in state data structure s. For a graph, where nodes are identified with a unique number, s_{n,c} might correspond to content at node n for class c in state data structure s.

The expression aₗ refers to content at location l in input data structure a. For example, a_{4,5,r} might correspond to the Red intensity value at location (4,5) in input data structure a, which can be an image.

Other color schemes can be used for the channel values, including but not limited to Red, Green, Blue, White; Cyan, Yellow, Magenta; Cyan, Yellow, Magenta, Black; Hue, Saturation, Value; Hue Saturation, Lightness; Hue, Saturation, Brightness; Munsell color system; Natural Color System; Preucil Hue Circle; CIELCHᵤᵥ; CIELCH_{ab}; CIECAM02; LCh; Pantone Machine System, Federal Standard 595C; British Standard Colour; RAL; and HKS.

A channel might also correspond to other parts of the spectrum such as non-visible parts, including but not limited to ultraviolet or infrared. In other applications, the values might include the depth of a location in terms of distance from a sensor in a camera to the location in the image or video. In a speech spectrogram, channels might correspond to frequency or frequency bands. Moreover, any number of dimensions, whether the aforementioned channels or not, can be used to index a and s.

In contrast to the image example, aₙ might correspond to content at a node n in input data structure a, which can be a graph. For example, in a graph, where nodes correspond to people and edges correspond to relationships between people, content at a node might correspond to characteristics of a person at the node.

The expression n(l, L) refers to one or more locations in proximity to location l for the set of locations L. This proximity can also be called a “neighborhood” or a “locality.” For example, an interior location x, y, r in an image input data structure and state data structure might comprise the following locations in proximity to x, y, r: (x,y,b), (x,y,g), (x+1,y,r), (x−1,y,r), (x,y+1,r), (x,y−1,r), (x+1,y,b), (x−1,y,b), (x,y+1,b), (x,y−1,b), (x+1,y,g), (x−1,y,g), (x,y+1,g), and (x,y−1,g).

In this example, location x,y,r corresponds to a Red (r) channel at location x,y. Note that the Blue (b) and Green (g) channels are included in proximity to the Red (r) channel. For example, (x,y,b) and (x,y,g) are in proximity to (x,y,r). As a result, embodiments of the subject matter can capture for classification not only spatial relationships between (x,y) coordinates, but also cross-channel relationships (e.g., between Red, Green, and Blue channels). For example, the intensity of a Red channel at a specific location might be related to the intensity of a Blue channel at the same location.

Many coordinate systems can be used to describe array coordinates. For example, the left side of an image typically corresponds to an x coordinate of 0 in and the upper side of an image corresponds to a y coordinate is 0. Thus, x coordinates increase from left to right and y coordinates increase from top to bottom. The upper-left (northwest) corner x,y,r might only have the following locations in proximity: (x,y,b), (x,y,g), (x+1,y,r), (x,y+1,r), (x+1,y,b), (x,y+1,b), (x+1,y,g), and (x,y+1,g).

A volumetric image might include four coordinates x,y,z, and d. The x,y,d coordinates are similar to those of an image and the z coordinate can correspond to depth and can start at 0 for the front plane and increase towards the back plane.

A video is similar to a volumetric image, except the video can comprise x,y,d,t coordinates, where t corresponds to time (frame number). Here, proximity can refer to nearness in time as well as x,y,d coordinates. Embodiments of the subject matter can leverage time in proximity for prediction.

Other definitions of proximity can be used. For example, diagonal proximity can be used. Similarly, proximity can be based on a hexagonal grid. The edges and corners can wrap around to their opposites. However, such wrap-arounds might make it appear that spatial distant locations are nearby. For example, the north edge can appear to be spatially close to the south edge when wrapped around.

The expressions n(l, L) and y(l, L) include L as one of the parameters because proximity can be defined relative to the set of locations L. For example, location 12 in a one-dimensional array might be a right-edge whereas location 12 in another one-dimensional, but longer array might be an interior location. Hence, the neighbor and location type functions include L to determine the neighbors and location type of inputs that vary in size and configuration.

The expression a_{n(l,L)} is shorthand notation for a content list (column vector) located in proximity to l in input data structure a relative to locations L. For example, a_{[(x,y,b),(x,y,g),(x+1,y,r),(x,y+1,r),(x+1,y,b),(x,y+1,b),(x+1,y,g),(x,y+1,g)]} corresponds to a column vector

$$[ \begin{matrix}{a}_{x , y , b} \\ {a}_{x , y , g} \\ {a}_{x + 1 , y , r} \\ {a}_{x , y + 1 , r} \\ {a}_{x + 1 , y , b} \\ {a}_{x , y + 1 , b} \\ {a}_{x + 1 , y , g} \\ {a}_{x , y + 1 , g}\end{matrix} ] .$$

The term “list” as used here refers to a sequence of indexable elements. Other synonyms for “list” as used here include but are not limited to: tuple, vector, sequence, one-dimensional array, and one-dimensional matrix.

Similarly, s_{n(l,L),c} is shorthand notation for a content list (discrete values) located in proximity to l for class c in state data structure s relative to locations L. For example, s_{[(x,y,b),(x,y,g),(x+1,y,r),(x,y+1,r),(x+1,y,b),(x,y+1,b),(x+1,y,g),(x,y+1,g)],c} corresponds to a list of states s_{x,y,b,c}, s_{x,y,g,c}, s_{x+1,y,r,c}, s_{x,y+1,r,c}, s_{x+1,y,b,c}, s_{x,y+1,b,c}, s_{x+1,y,g,c}, s_{x,y+1,g,c}.

The expression y(l,L) corresponds to the type of the location l relative to location set L. For a state data structure associated with an image, the location type might comprise the following types: nwd (the upper left corner), ned (the upper right corner), swd (the lower left corner), sed (the lower right corner), wd (the left edge), ed (the right edge), nd (the upper edge), sd (the lower edge), or id (the interior of the image). Here the d corresponds to the channel, which can be r, b, or g. In this example, the location type comprises 27 different types. In other applications, the corners might be indistinguishable from each other and the edges might be indistinguishable from each other. In other words, y(l,L) can be defined for each application.

Location type can also be encoded as a probability function for each location type. For example, p_{swr} can encode a probability function associated with a southwest corner for the Red channel. This method of encoding can be more cumbersome for notation, but captures the same idea: all probability functions can be dependent on location type.

The function p(aₗ, t|y (l, L), c) corresponds to a probability of content aₗ and state value t conditioned on location type y(l,L) and class c. (Here, the term “state value” and “state” are used interchangeably.) The function

$${random}_{t ∈ S} \{ p ( {a}_{l} , t \vert y ( l , L ) , c ) \}$$

generates a sample t∈S at random and based on p(aₗ,t|y(l, L), c). For example, fora particular aₗ, y(l, L), and c states t=1, t=2, and t=3 might correspond to probabilities p(aₗ, 1|y(l, L), c)=0.5, p(aₗ, 2|y(l, L), c)=0.2, and p(aₗ, 3|y(l, L), c)=0.3. Hence, t=1, t=2, and t=3 will be sampled based on these three probabilities. This function can be used to initialize state matrix s. Note that this initialization is not based on locations in proximity to l, but only on l. In contrast, Step 2 is based on locations in proximity to l.

The function p(aₗt|a_{n(l,L)}, s_{n(l,L),c}y(l, L), c) corresponds to a probability of content aₗ and state value t conditioned on input data structure content a_{n(l,L)}, state data structure content s_{n(l,L),c}, location type y(l,L), and class c. This function can be used to update the state data structure s through state data structure s′. This update can occur repeatedly.

As mentioned, the probability function p(aₗ, r|a_{n(l,L)}, s_{n(l,L),c}, y(l, L), c) can be alternatively expressed with multiple different probability functions, one for each location type. For example, a nw red corner location can explicitly list a_{n(l,L)} and s_{n(l,L),c}, instead of generating those from n(l, L): when x=y=0 and the channel is Red, use function

$${p}_{n w r} ( {a}_{l} , t \vert [ \begin{matrix}{a}_{x , y , b} \\ {a}_{x , y , g} \\ {a}_{x + 1 , y , r} \\ {a}_{x , y + 1 , r} \\ {a}_{x + 1 , y , b} \\ {a}_{x , y + 1 , b} \\ {a}_{x + 1 , y , g} \\ {a}_{x , y + 1 , g}\end{matrix} ] , {s}_{x , y , b} , {s}_{x , y , g} , {s}_{x + 1 , y , r} , {s}_{x , y + 1 , r} , {s}_{x + 1 , y , p} , {s}_{x , y + 1 , b} , {s}_{x + 1 , y , g} , {s}_{x , y + 1 , g} ) .$$

Here, p_{nwr} is a special-purpose probability function, applicable only to a northwest corner red channel location. Four edge types, four corner types, and an interior location type—each with 3 channels—can require 15 special-purpose functions. A graph can be based on a special-purpose probability function for each node. The special-purpose functions are equivalent to the compact notation above, which explicitly mentions n(l, L) and y(l, L).

In function p(v, t|vn, sn, y, c), v corresponds to content, t corresponds to a state, vn corresponds to content at neighbor locations (i.e., those in proximity), sn corresponds to states at neighbor locations, y corresponds to location type, and c corresponds to the class.

Function p(v, t|vn, tn, y, c) can be defined as the product of two functions: p(v|t, vn, tn, y, c)p(t|tn, y, c). If v and vn are continuous, p(v|t, vn, tn, y, c) can be defined as [symbol] (v, [symbol] (vn, μ_{t,tn,y,c}, Σ_{t,tn,y,c}), [symbol] (Σ_{t,tn,y,}c)). Here [symbol] corresponds to a multivariate Gaussian distribution with mean [symbol] (vn, μ_{t,tn,y,c}, Σ_{t,tn,y,c}) and covariance [symbol] (Σ_{t,tn,y,c}) and v is a column vector of one or more continuous values. For example, v can be an intensity value at the particular location l in an image (recall that a location in an image comprises an x, y location and a channel).

The variable vn comprises the values at neighbor locations (i.e. the values at locations in proximity to l). The values can be continuous or discrete. If the values are continuous, they can be structured as a column vector for input to a conditional Gaussian distribution. For example, if l is (x,y,r) and x=y=0, vn comprises

$$[ \begin{matrix}{a}_{x , y , b} \\ {a}_{x , y , g} \\ {a}_{x + 1 , y , r} \\ {a}_{x , y + 1 , r} \\ {a}_{x + 1 , y , b} \\ {a}_{x , y + 1 , b} \\ {a}_{x + 1 , y , g} \\ {a}_{x , y + 1 , g}\end{matrix} ] .$$

The expression μ_{t,tn,y,c} refers to the mean input values for state value t with neighbor state values tn, location type y, and class c. For example, if l is (x,y,r) and x=y=0, tn comprises s_{x,y,b,c}, s_{x,y,g,c}, s_{x+1,y,r,c}, s_{x,y+1,r,c}, s_{x+1,y,b,c}, s_{x,y+1,b,c}, s_{x+1,y,g,c}, s_{x,y+1,g,c}. This list can be represented in multiple different ways (e.g., as a vector, as a list, as tuples) as an index into a mean vector and a covariance matrix. Similarly, Σ_{t,tn,y,c} refers to the covariance of the input values for state value t with neighbor state values tn, location type y, and class c.

The functions [symbol] , [symbol] , and [symbol] are defined as below.

$$𝒩 ( v , μ , \sum ) = \frac{1}{\sqrt{\vert 2 π \sum \vert}} exp [ - \frac{1}{2} {( v - μ )}^{T} {\sum }^{- 1} ( v - μ ) ]$$

$$𝒢 ( v , μ , \sum ) = \dot{μ} + \hat{\sum } {\ddot{\sum }}^{- 1} ( v - \ddot{μ} ) ℋ ( \sum ) = \dot{\sum } + \hat{\sum } {\ddot{\sum }}^{- 1} {\hat{\sum }}^{T}$$

The function |2πΣ| in the definition of [symbol] refers to a determinant, Σ⁻¹ is the inverse of Σ, and the superscript T refers to matrix transposition. These are all standard and common matrix operations; hence, they will not be described here.

Furthermore, [symbol] (vn, μ, Σ) is the mean of a conditional Gaussian and [symbol] (Σ) is the covariance of a conditional Gaussian. The superscript −1 in the matrix \ddot{Σ}⁻¹ in [symbol] and [symbol] refers to matrix inversion and superscript T in Ê^{T} in [symbol] refers to matrix transposition.

In order to describe [symbol] (v, μ, Σ) and [symbol] (Σ) and for convenience of notation, it is assumed that μ and Σ for any t, tn, y, c are conformably partitioned as

$$μ = [ \begin{matrix}\dot{μ} \\ \ddot{μ}\end{matrix} ] \sum = [ \begin{matrix}\dot{\sum } & \hat{\sum } \\ {\dot{\sum }}^{T} & \ddot{\sum }\end{matrix} ] .$$

Here, \dot{μ} and \dot{Σ} refer to the mean vector and covariance matrix, respectively, for aₗ with state t, neighbor states tn, location type y, and class c. Similarly, \ddot{μ} and \ddot{Σ} refer to the mean vector and covariance matrix, respectively, of the values in proximity to l in a for t, tn, y, c.

In addition, Ê is a covariance between the aₗ, and the values (content) in the neighborhood of l in a—both for state t with neighbor states tn, location type y, and class c. This conformable partition applies to mean vectors and covariance matrices of all location types, all classes, and all states.

The product p(v|vn, t, tn, y, c) p(t|tn, y, c) is similar to a Gaussian Mixture Model, except in a Gaussian Mixture Model, the probability is defined as p(v|t)p(t). In contrast, in embodiments of the subject matter, t is conditioned on neighbor state values (as well as y and c). Moreover, v in embodiments of the subject matter is also conditioned on the neighbors vn as well as t, tn, y, c.

As mentioned above, the function p(v, t|vn, tn, y, c) can be defined as the product of two functions, p(v|t, vn, tn, y, c)p(t|tn, y, c), where the first function in the product can be based on a (conditional) Gaussian distribution. A major advantage of modeling with the Gaussian distribution is that vn can scale to multiple values per location: each of the multiple values per location can be stacked into vector. In contrast, if vn is discrete the function p(v, t|vn, tn, y, c) can be modeled as a Bayesian Network, but this network does not scale as vn increases in size. Moreover, v can also be multiple values. Multiple values in v can scale in a Bayesian Network, by for example, assuming conditional independence.

The variable v can be a vector (or more generally a two-dimensional array) and vn can be a vector (or more generally an array) of stacked values for the neighbors. The stacking as a vector is merely an input form convenient for a Gaussian distribution, whose inputs are assumed to be in the form of a vector.

The function p(t|tn, y, c) is the probability of a state t given a neighborhood of states tn, location type y, and class c. This function can be modeled as a discrete probability distribution such as a Bayesian Network.

Step 1 initializes the state data structure s over each location l for each class c. The function random randomly chooses one of the state values based on the distribution p(aₗ, s_{l,c}|y(l, L), c).

For an image, the locations L can comprise an m×n×3 set of tuples one for each x,y location and each channel (r, g, and b), where m is the width of the image, n is the height of the image, and the number of channels is three.

Step 2 creates data structure s′ for each location l and each class c based on state data structure s and input data structure a. Step 3 sets state data structure s to state data structure s′. This step has the effect of propagating a state value throughout the locations of the data structure s for each class c.

The termination criteria can include a specified number of iterations or until the likelihood converges. The likelihood function can be defined as Σ_{c∈C} p(c)z(c), where z(c) is defined as below.

z(c)=Π_{l∈L}p(aₗ,s_{l,c}|a_{n(l,L)},s_{n(l,L),c},y(l,L),c)

Here, p(c) is the probability of the class c. Alternatively, the likelihood function can be defined as

$${max}_{c ∈ C} \{ p ( c ) z ( c ) \} .$$

The first likelihood function is averaged over the probability of each class and the second likelihood is instead maximized.

Other termination criteria is possible to define. For example, embodiments of the subject matter can execute 2-3 a specified number of times.

Once the termination criteria are met, the most likely class is

$${argmax}_{c ∈ C} \{ p ( c ) z ( c ) \} .$$

This most likely class can be returned as the predicted class for a particular input data structure a and state data structure s.

Multiple random restarts can be used to determine a most likely class over all the restarts—the one with the highest likelihood can be chosen. Here, a random restart refers to the random sample in Step 1. Alternatively, a most frequent most likely class among multiple random restarts can be returned as the best one.

All of the above expressions can be simplified by applying a log transformation and applying argmin over the negative of the returned value instead of argmax. In this case, the exponentiation in [symbol] can be removed. Similarly, the determinant in [symbol] can be changed to a log-determinant.

The result of the aforementioned log transformation, which essentially replaces products with sums of the logs, is equivalent to the original expressions, except that sums instead of products are involved as well as some sign changes and minimization (argmin) instead of maximization (argmax). In general, sums are simpler to compute than products.

Computationally, matrix transposition can be accomplished efficiently (i.e., in linear time based on the number of rows or columns in the matrix). Matrix inversion can be accomplished in O(n^{2.3}) time, where n the number of rows (columns) of a square matrix. As the number of rows or columns for matrix inversion is proportional to the number of neighbors, matrix inversion can be accomplished efficiently. Moreover, an inverted matrix for each location type, channel, and class can be precomputed once and re-used by embodiments of the subject matter.

In some classification applications, the exact rotation, warping, reflection, or size of an object in an image might be important. For example, one classification task might involve discriminating between an image with a letter “A” rotated 90 degrees left and a letter “A” rotated 90 degrees to the right. In this situation, generalizing over rotations is undesirable.

Other embodiments of the subject matter can rotate, reflect, and transform the list of proximal locations n(l,L) to find those rotations, reflections, or transformations r that maximize p(aₗ, s_{l,c}|aᵣ, s_{r,c}, y(l, L), c). For example, the neighbors of a corner in a two-dimensional array can be reflected right-left, up-down, and through the diagonal. The n neighbors of a node in a graph can be permuted n! ways. Permutations comprise rotations and reflections and can facilitate generalization during classification.

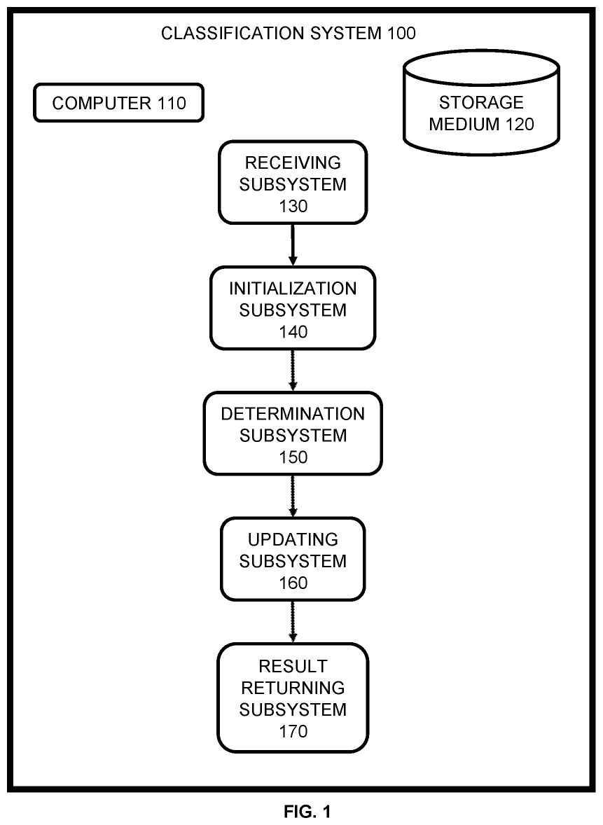

FIG. 1 shows an example classification system 100 in accordance with an embodiment of the subject matter. Classification system 100 is an example of a system implemented as a computer program on one or more computers in one or more locations (shown collectively as computer 110), with one or more storage devices (shown collectively as computer-readable storage medium 120), in which the systems, components, and techniques described below can be implemented.

During operation, classification system 100 receives input data structure a with receiving subsystem 130. For example, input data structure a for an image classification task comprises a three-dimensional matrix of x, y, d, coordinates, where x is the horizontal coordinate, y is the vertical coordinate, and d is the channel (r, g, or b). Content at each x, y, d location corresponds to an intensity value.

Next, classification system 100 initializes state data structure s with initialization subsystem 140, where state data structure s is indexed similarly to input data structure a. An indexed similarly state data structure comprises the same indexing method (e.g., x, y, d) but can contain different content. For example, a state data structure comprises discrete states rather than intensity values.

Subsequently, classification system 100 determines content at location l in state data structure s′ based on content at location l in input data structure a, state value t, content at location m in state data structure s, and content at location n in state data structure s. Here, location m is in proximity to location l, location n is in proximity location l, location m is different from location n, and state data structure s′ is indexed similarly to state data structure s. Classification system 100 determines content at location l in state data structure s′ with determination subsystem 150. A location corresponds to an index in memory for a particular data structure. As mentioned above, proximity can correspond to nearness in space, time, channel, memory, or relationship. More generally, proximity can be defined based on any distance metric between two locations in a data structure. Proximity to a location l can be determined with n(l, L), where l corresponds to a location and L is the set of locations.

Next, classification system 100 updates content at location l in state data structure s based on content at location l in state data structure s′. Classification system 100 updates content at location l in state data structure s with updating subsystem 160.

Subsequently, classification system 100 returns a result indicating a class based on input data structure a and state data structure s with resulting returning subsystem 170. Determining content at location l in state data structure s′s′ based on content at location l in input data structure a, state value t, content at location m in state data structure s, and content at location n in state data structure s and updating content at location l in state data structure s based on content at location l in state data structure s′ can repeat multiple times until the termination criteria is met.

Embodiments of the subject matter can be used to learn a model comprising various mean vectors, covariance matrices, and probability functions based on training data comprising rows of the data structure a together with a class. During operation, an embodiment of the subject matter can execute the following steps for learning the model:
1. ∀l∈Lᵢ, ∀i: 1≤i≤k:s_{l,c}_{ᵢ}_{,i}=random(S)
2. Determine model's parameters (e.g., μ, Σ, and p) based on s and a.

$$∀ l ∈ {L}_{i} , ∀ i : 1 \leq i \leq k : {s}_{l , {c}_{i} , i}^{′} = {argmax}_{t ∈ S} \{ p ( {a}_{l , i} , t \vert {a}_{n ( l , {L}_{i} ) , i} , {s}_{n ( l , {L}_{i} ) {c}_{i} , i} , y ( l , {L}_{i} ) , {c}_{i} ) \} \qquad 3.$$

4. s=s′
5. Repeat steps 2-4 until termination criteria is met.

In these steps, i corresponds to the row number of the training data (1≤i≤k), Lᵢ corresponds to the locations associated with the i^{th} training example, and cᵢ corresponds to the class associated with the i^{th} training example. Furthermore, s_{l,c}_{ᵢ}_{,i} refers to the state at location l for class cᵢ for training example i. The expressions a_{l,i}, a_{n(l,L}_{ᵢ}_{),i}, and s_{n(l,L}_{ᵢ}_{),c}_{ᵢ}_{,i} are similarly indexed by the i^{th} training example. Typically, training examples are arranged in rows, but the manner of presentation of a training example might depend upon the data structure a.

Step 1 randomly sets the state values for each location of each location and each training example and corresponding class. For example, the state values can be chosen from a uniform probability distribution: each state can be selected with probability 1/|S|. Step 2 determines the parameters μ, Σ, and probability functions p for all classes and all locations types based on s and the training examples. For example, the mean Red, Green, and Blue intensity values can be determined for the location type is the nw corner with state value 1 and neighbor state values of 2 and 3. More generally, this mean can be determined for the Red, Green, and Blue intensity values for each location type, state at the location, and states and intensities at neighbor locations. The covariance matrix and discrete probability functions can be similarly determined. This determination is based on the a and the current values of s, which can change with each iteration. Note that determining the parameters is based on the entire set of training examples and the current setting of states for each location, each class, and each training example.

Once these parameters are set, Step 3 finds the most likely states for each location of each training example of each state. Step 4 sets the states to be these most likely states. This process then repeats steps 2-4 until the termination criteria is met. The process can terminate after a certain number of steps or until the likelihood of the data given the parameters (the likelihood function is defined below) does not significantly change. Multiple random restarts can be cross-compared with a reserved validation set: the best set of parameters are those that maximize the likelihood of the reserved validation set.

The likelihood function over the k training examples can be defined as Πᵢ₌₁^{k}p(cᵢ)Π_{l∈L}p(a_{l,i}s_{l,c,i}| a_{n(l,L),i}, s_{n(l,L),c,i}, y(l,L),cᵢ).

Note that steps 1 and 3 can be parallelized over each training example and each location of each training example. In addition, step 2 can be parallelized to determine frequencies, means, and covariance matrices using a divide-and-conquer method on the data. For example, the mean is a sum divided by a total. The sum can be computed on multiple portions of the data in parallel and then combined. Step 1 can also be parallelized with multiple random restarts.

Any current or to-be-invented machine learning method can be used to determine the mean vectors, covariance matrices, and transition probabilities. A preferred method in embodiments of the subject matter can determine the mean vectors, covariance matrices, and discrete probabilities directly based on the training data and current set of states. This is similar to how the Expectation-Maximization method operates with Gaussian Mixtures except here the conditional state probabilities (i.e., the transition functions) are recursively defined (i.e., they never bottom out as in the Expectation-Maximization method) and the Gaussian Mixtures are based on location types, proximity, and as well as classes.

Embodiments of the subject matter can discover an appropriate number of states based on finding a point of diminishing returns in the number of states with the likelihood function applied to yet another reserved set of one or training examples. Too few states can lead to prediction errors; too many states can lead to overfitting. Between these two extremes lies a sweet spot in the number of states. This sweet spot can be specific to a type of input or more generally applicable across a variety of similar inputs.

Embodiments of the subject matter can also segment an input data structure into states, one per location with either unsupervised or supervised segmentation. For example, each location can in a medical image can be classified as cancerous or non-cancerous. In this embodiment, the state corresponds to a location. In either case, segmentation can be viewed as special case of classification (i.e., one with a single class). Mathematically, segmentation is a special case of classification (i.e., with a single class). Hence everything previously described about embodiments of the subject matter in classification also holds for segmentation.

Given a model's parameters (e.g., μ, Σ, and p), embodiments of the subject matter can accomplish segmentation (unsupervised or supervised) by executing the following steps:

$$∀ l ∈ L : {s}_{l} = {random}_{t ∈ S} \{ p ( {a}_{l} , t \vert y ( l , L ) ) \} \qquad 1.$$

$$∀ l ∈ L : {s}_{l}^{′} = {argmax}_{t ∈ S} \{ p ( {a}_{l} , t \vert {a}_{n ( l , L )} , {s}_{n ( l , L )} , y ( l , L ) ) \} \qquad 2.$$

3. s=s′
4. Repeat steps 2-3 until termination criteria is met.

These steps are similar to those of classification, except that the class is missing. The Step 1 samples from the distribution p(aₗ, t|y(l, L)) to choose initial values of states for each location. Step 2 finds a most likely value state value for each location and Step 3 updates the state data structure. The functions p can be defined as before, except there is no parameter corresponding to the class c. Note that p(aₗ, t|y(l, L)) and p(aₗ,t|a_{n(l,L)}, s_{n(l,L)}, y(l, L)) can be learned from training data even if a label (class) is missing from the data. A most likely segmentation over multiple different random restarts can be found with the likelihood function Π_{l∈L} p(aₗ, sₗ|a_{n(l,L)}, s_{n(l,L)}, y(l, L)).

Embodiments of the subject matter can also learn the model's parameters (e.g., μ, Σ, and p) based on training examples, even from a single training example:
1. ∀l∈Lᵢ, ∀i: 1≤i≤k: s_{l,i}=random(S)
2. Determine model's parameters (e.g., μ, Σ, and p) based on s and a.

$$∀ l ∈ {L}_{i} , ∀ i : 1 \leq i \leq k : {s}_{l , i}^{′} = {argmax}_{t ∈ S} \{ p ( {a}_{l , i} , t \vert {a}_{n ( l , {L}_{i} ) , i} , {s}_{n ( l , {L}_{i} ) , i} , y ( l , {L}_{i} ) ) \}$$

4. s=s′
5. Repeat steps 2-4 until termination criteria is met.

In these steps, i corresponds to the row number of the training data (1≤i≤k), Lᵢ corresponds to the locations associated with the i^{th} training example. Furthermore, s_{l,i} refers to the state at location l for training example i. The expressions a_{l,i}, a_{n(l,L}_{ᵢ}_{),i}, and s_{n(l,L}_{ᵢ}_{),i} are similarly indexed by the i^{th} training example. Typically, training examples are arranged in rows, but the manner of presentation of a training example might depend upon the data structure a. For each location in each training example, Step 1 generates a random assignment of state values. For example, each state value can be sampled with probability 1/|S| in this step. Step 2 determines a most likely next value for each location in each training example. Step 3 updates the state value data structures to the most likely values for each location in each training example. This process then repeats until convergence. A most likely segmentation can be found with the likelihood function Π_{l∈L}p(aₗ, sₗ|a_{n(l,L)}, s_{n(l,L)}, y(l, L)). The best model is the one that is associated with the highest likelihood over all random restarts. The functions p are defined as before except there is no parameter corresponding to a class.

Embodiments of the subject matter can be flexibly used in classification and for segmentation—supervised or unsupervised—and can be learned from training data. Note that unlike in HMIs, the maximization is over the target location not over the locations that feed into the target. Also unlike in HMIs, the probabilities never bottom out: they are recursively and circularly defined in embodiments of the subject matter. Because of this circular definition, embodiments of the subject matter initialize the state data structure and update it with every iteration.

In embodiments of the subject matter, convergence is not guaranteed. In the situation where state values oscillate during prediction and learning, termination criteria involving a fixed number of iterations can be used instead of likelihood. This is because oscillation may occur between two equally likely models.

Recurrent Neural Networks (RNNs) feed previous outputs as inputs and use “hidden” units. However, these feeds are cascaded just as in an HMM: the output of one hidden unit feeds into the input of another. In a neural network, this feed is merely capturing the idea of a conditional probability function where the state at location x in a sequence dependent on a state at location x−1. This is not the same as repeatedly updating all state values based on propagation from content of states and inputs associated with locations in proximity. In short, RNNs are like HMIs but without the efficiency of Dynamic Programming but are unlike Resonators because they don't update state values and repeatedly propagate the updated values. Moreover, both RNNs and HMMs propagate state information based only the previous location's state values, not two or more state values in proximity to the location of a state.

Neural nets have long claimed to be biologically inspired. Although Resonators are not biologically inspired and are not a type of neural network, they have several characteristics that make them more biologically more plausible than neural networks or deep learning.

For example, neurons in mammals can be excited or inhibited laterally by neurons in proximity until the neurons settle to a particular configuration. This “settling” is similar to how Resonators both classify and learn: they propagate information in all directions through proximity and settle on states that appear to be most likely. In contrast, neural networks and deep learning operate forward during prediction and both forward and backward during learning. They do not appear to propagate information based on proximity.

Propagation by proximity does not make Resonators more biologically plausible, but it does suggest that propagation by proximity might be a general optimality principle obeyed by any perceptual system, whether natural or artificial. For example, neurons in proximity tend to be connected and propagate information to each other. In contrast, there is little evidence that mammalian brains backpropagate, Convolve, Pool, and apply ReLU-like operations.

The preceding description is presented to enable any person skilled in the art to make and use the subject matter, and is provided in the context of a particular application and its requirements. Various modifications to the disclosed embodiments will be readily apparent to those skilled in the art, and the general principles defined herein may be applied to other embodiments and applications without departing from the spirit and scope of the subject matter. Thus, the subject matter is not limited to the embodiments shown, but is to be accorded the widest scope consistent with the principles and features disclosed herein.

Embodiments of the subject matter and the functional operations described in this specification can be implemented in digital electronic circuitry, in tangibly embodied computer software or firmware, in computer hardware, including the structures disclosed in this specification and their structural equivalents, or in combinations of one or more of them.

Embodiments of the subject matter described in this specification can be implemented as one or more computer programs, i.e., one or more modules of computer program instructions encoded on a tangible non-transitory program carrier for execution by, or to control the operation of data processing system.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

Alternatively, or in addition, the program instructions can be encoded on an artificially generated propagated signal, e.g., a machine-generated electrical, optical, or electromagnetic signal, that is generated to encode information for transmission to a suitable receiver system for execution by a data processing system. The computer storage medium can be a machine-readable storage device, a machine-readable storage substrate, a random or serial access memory device, or a combination of one or more of them.

Computers suitable for the execution of a computer program include, by way of example, can be based on general or special purpose microprocessors or both, or any other kind of central processing unit. Generally, a central processing unit will receive instructions and data from a read only memory or a random-access memory or both. The essential elements of a computer are a central processing unit for performing or executing instructions and one or more memory devices for storing instructions and data.

A computer can also be distributed across multiple sites and interconnected by a communication network, executing one or more computer programs to perform functions by operating on input data and generating output.

A computer can also be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Generally, a computer will also include, or be operatively coupled to receive data from or transfer data to, or both, one or more mass storage devices for storing data, e.g., magnetic, magneto optical disks, or optical disks. However, a computer need not have such devices.

The term “data processing system’ encompasses all apparatus, devices, and machines for processing data, including by way of example a programmable processor, a computer, or multiple processors or computers.

For a system of one or more computers to be configured to perform particular operations or actions means that the system has installed on it in software, firmware, hardware, or a combination of them that in operation cause the system to perform the operations or actions. For one or more computer programs to be configured to perform particular operations or actions means that the one or more programs include instructions that, when executed by data processing system, cause the system to perform the operations or actions.

The processor and the memory can be supplemented by, or incorporated in, special purpose logic circuitry. More generally, the processes and logic flows can also be performed by and be implemented as special purpose logic circuitry, e.g., an FPGA (field programmable gate array) or an ASIC (application specific integrated circuit), a dedicated or shared processor that executes a particular software module or a piece of code at a particular time, and/or other programmable-logic devices now known or later developed. When the hardware modules or system are activated, they perform the methods and processes included within them.

The system can also include, in addition to hardware, code that creates an execution environment for the computer program in question, e.g., code that constitutes processor firmware, a protocol stack, a database management system, an operating system, or a combination of one or more of them.

The computer-readable storage medium includes, but is not limited to, volatile memory, non-volatile memory, magnetic and optical storage devices such as disk drives, magnetic tape, CDs (compact discs), DVDs (digital versatile discs or digital video discs), computer instruction signals embodied in a transmission medium (with or without a carrier wave upon which the signals are modulated), and other media capable of storing computer-readable media now known or later developed. For example, the transmission medium may include a communications network, such as a LAN, a WAN, or the Internet.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

The methods and processes described in the detailed description section can be embodied as code and/or data, which can be stored in a computer-readable storage medium as described above. When a computer system reads and executes the code and/or data stored on the computer-readable storage medium 120, the computer system performs the methods and processes embodied as data structures and code and stored within the computer-readable storage medium.

The components of the system can be interconnected by any form or medium of digital data communication, e.g., a communication network. Examples of communication networks include a local area network (“LAN”) and a wide area network (“WAN”), e.g., the Internet.

While this specification contains many specific implementation details, these should not be construed as limitations on the scope of any subject matter or of what may be claimed, but rather as descriptions of features that may be specific to particular embodiments of particular subject matters. Certain features that are described in this specification in the context of separate embodiments can also be implemented in combination in a single embodiment.

Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system modules and components in the embodiments described above should not be understood as requiring such separation in all embodiments, and it should be understood that the described program components and systems can generally be integrated together in a single software product or packaged into multiple software products.

The foregoing descriptions of embodiments of the subject matter have been presented only for purposes of illustration and description. They are not intended to be exhaustive or to limit the subject matter to the forms disclosed. Accordingly, many modifications and variations will be apparent to practitioners skilled in the art. Additionally, the above disclosure is not intended to limit the subject matter. The scope of the subject matter is defined by the appended claims.

What is claimed is:

1. A computer-implemented method for facilitating classification comprising:
receiving input data structure a;
initializing state data structure s, wherein state data structure s is indexed similarly to input data structure a;
determining content at location l in state data structure s′ based on content at location l in input data structure a, state value t, content at location m in state data structure s, and content at location n in state data structure s,
wherein location m is in proximity to location l,
wherein location n is in proximity location l,
wherein location m is different from location n, and
wherein state data structure s′ is indexed similarly to state data structure s;
updating content at location l in state data structure s based on content at location l in state data structure s′; and
returning a result indicating a class based on input data structure a and state data structure s.

2. The method of claim 1, wherein determining content at location l in state data structure s′ comprises:
determining a first probability based on a first function, content at location l in input data structure a, and state value t; and
determining a second probability based on a second function, state value t, content at location m in state data structure s, and content at location n in state data structure s.

3. The method of claim 2, wherein determining the first probability comprises determining a conditional Gaussian probability.

4. The method of claim 2, wherein determining the first probability is additionally based on content at location m in input data structure a and content at location n in input data structure a.

5. The method of claim 2, wherein determining the first probability is additionally based on content at location m in state data structure s and content at location n in state data structure s.

6. The method of claim 2, wherein the first function and second function are learned from training data.

7. One or more non-transitory computer-readable storage media storing instructions that when executed by one or more computers cause the one or more computers to perform operations for facilitating classification, comprising:
receiving input data structure a;
initializing state data structure s, wherein state data structure s is indexed similarly to input data structure a;
determining content at location l in state data structure s′ based on content at location l in input data structure a, state value t, content at location m in state data structure s, and content at location n in state data structure s;
wherein location m is in proximity to location l,
wherein location n is in proximity location l,
wherein location m is different from location n, and
wherein state data structure s′ is indexed similarly to state data structure s;
updating content at location l in state data structure s based on content at location l in state data structure s′; and
returning a result indicating a class based on input data structure a and state data structure s.

8. The one or more non-transitory computer-readable storage media of claim 7, wherein determining content at location l in state data structure s′ comprises:
determining a first probability based on a first function, content at location l in input data structure a, and state value t; and
determining a second probability based on a second function, state value t, content at location m in state data structure s, and content at location n in state data structure s.

9. The one or more non-transitory computer-readable storage media of claim 8, wherein determining the first probability comprises determining a conditional Gaussian probability.

10. The one or more non-transitory computer-readable storage media of claim 8, wherein determining the first probability is additionally based on content at location m in input data structure a and content at location n in input data structure a.

11. The one or more non-transitory computer-readable storage media of claim 8, wherein determining the first probability is additionally based on content at location m in state data structure s and content at location n in state data structure s.

12. The method of claim 8, wherein the first function and second function are learned from training data.

13. A system comprising one or more computers and one or more storage devices storing instructions that when executed by the one or more computers cause the one or more computers to perform operations for facilitating classification, comprising:
receiving input data structure a;
initializing state data structure s, wherein state data structure s is indexed similarly to input data structure a;
determining content at location l in state data structure s′ based on content at location l in input data structure a, state value t, content at location m in state data structure s, and content at location n in state data structure s,
wherein location m is in proximity to location l,
wherein location n is in proximity location l,
wherein location m is different from location n, and
wherein state data structure s′ is indexed similarly to state data structure s;
updating content at location l in state data structure s based on content at location l in state data structure s′; and
returning a result indicating a class based on input data structure a and state data structure s.

14. The system of claim 13, wherein determining content at location l in state data structure s′ comprises:
determining a first probability based on a first function, content at location l in input data structure a, and state value t; and
determining a second probability based on a second function, state value t, content at location m in state data structure s, and content at location n in state data structure s.

15. The system of claim 14, wherein determining the first probability comprises determining a conditional Gaussian probability.

16. The system of claim 14, wherein determining the first probability is additionally based on content at location m in input data structure a and content at location n in input data structure a.

17. The system of claim 14, wherein determining the first probability is additionally based on content at location m in state data structure s and content at location n in state data structure s.

18. The system of claim 14, wherein the first function and second function are learned from training data.
